(19) United States
(12) Patent Application Publication
(10) Pub. No.: US 2017/0076383 A1
(43) Pub. Date: Mar. 16, 2017

(54) SYSTEM FOR RESTRUCTURING BASED ON INTENT ANALYSIS

(71) Applicant: BANK OF AMERICA CORPORATION, Charlotte, NC (US)

(72) Inventors: Katherine Dintenfass, Charlotte, NC (US); Scott R. Enscoe, Charlotte, NC (US); Alicia C. Jones-McFadden, Fort Mill, SC (US); Matthew Hsieh, Charlotte, NC (US); Kevin Andrew O'Neil, JR., Hamilton, NJ (US); William F. Borowski, Millbury, MA (US); Minh Nguyen Vuong, Clovis, CA (US)

(21) Appl. No.: 14/853,649

(22) Filed: Sep. 14, 2015

(51) Int. Cl. G06Q 40/06

(52) U.S. Cl. CPC G06Q 40/06

(57) ABSTRACT

The present disclosure describes restructuring accounts and assets of a user based on analysis of the intentions of the user and/or beneficiaries to the accounts of the user. Embodiments herein disclosed describe systems, methods, and computer program products for receiving information about a user, accounts associated with the user, and beneficiaries associated with the accounts. Some embodiments include receiving intentions of the user and/or the beneficiaries, including goals and investment strategies for how the user and the beneficiary wish to manage the funds in the user's accounts. Some embodiments include determining at least one asset structure model based on the accounts of the user, the user information, the beneficiary information, and the intentions of the user and/or the beneficiaries. In some embodiments, the user may select an asset structure model, which will then be applied to the accounts of the user.

### FIELD OF THE INVENTION

This disclosure generally relates to restructuring assets based on party intent, planning and determination.

### BACKGROUND

Structuring an individual's accounts and assets can be accomplished through di

[symbol]

Distribution of one's assets to one's beneficiaries according to one's wishes can be very intricate and time-consuming. An entity that controls the individual's accounts may establish conversations with the individual to determine the most appropriate account organization model based on the intent of the individual. Additionally, the intent of any account beneficiaries should be taken into consideration. Therefore the entity may establish conversations with the beneficiaries and use the beneficiary input in determining how to structure the accounts.

### SUMMARY OF THE INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Methods, systems, and computer program products are described herein that provide for restructuring accounts and assets based on intent analysis. Some embodiments of the invention generally involve receiving and identifying the investment and management intent of an account owner as well as the investment and management intent of at least one beneficiary to the account. Additionally, some embodiments include using the determined or identified intents of the account owner and the at least one beneficiary to structure the assets and/or accounts of the account to meet the intents of all parties involved.

Some embodiments characterize a system that includes a computer apparatus including at least one processor and a memory, and a software module, stored in the memory, including computer readable code executable by the processor. The software module is configured to provide an online asset structuring application that enables a user to access one or more the user's accounts and input beneficiary information, and the asset structuring application includes at least one electronic interface including a chat function, wherein the beneficiary information includes one or more beneficiaries, funds designated to each of the beneficiaries and the user's intended use of the funds designated to each of the beneficiaries. The software module is further configured to receive, via the asset structuring application, the beneficiary information inputted by the user; and analyze the received beneficiary information to determine the user's intention on how to use the funds designated to each of the beneficiaries, wherein analyzing includes interactive real-time communication with the user via the chat function. The software module is additionally configured to form an asset structure, based at least partially on determination of the user's intention, and enable the user to verify the asset structure.

Some embodiments feature a computer implemented method that includes the step of providing an online asset structuring application that enables a user to access one or more the user's accounts and input beneficiary information, and the asset structuring application includes at least one electronic interface including a chat function, wherein the beneficiary information includes one or more beneficiaries, funds designated to each of the beneficiaries and the user's intended use of the funds designated to each of the beneficiaries. The method further includes the steps of receiving, via the asset structuring application, the beneficiary information inputted by the user; and analyzing the received beneficiary information to determine the user's intention on how to use the funds designated to each of the beneficiaries, wherein analyzing includes interactive real-time communication with the user via the chat function. The method additionally includes the step of forming an asset structure, based at least partially on determination of the user's intention, and enable the user to verify the asset structure.

Further embodiments provide a computer program product that includes a non-transitory computer readable medium including computer readable instructions. The computer readable instructions include instructions for providing an online asset structuring application that enables a user to access one or more the user's accounts and input beneficiary information, and the asset structuring application includes at least one electronic interface including a chat function, wherein the beneficiary information includes one or more beneficiaries, funds designated to each of the beneficiaries and the user's intended use of the funds designated to each of the beneficiaries. The computer readable instructions further include instructions for receiving, via the asset structuring application, the beneficiary information inputted by the user; and analyzing the received beneficiary information to determine the user's intention on how to use the funds designated to each of the beneficiaries, wherein analyzing includes interactive real-time communication with the user via the chat function. The computer readable instructions additionally include instructions for forming an asset structure, based at least partially on determination of the user's intention, and enable the user to verify the asset structure.

In some implementations, the software module is further configured to provide an online beneficiary viewer application that enables each of the beneficiaries to view the beneficiary information associated with the beneficiary, the viewer application includes at least one electronic interface including an interactive communication function and is configured to enable the beneficiary to input information including the beneficiary's intended use of the funds designated thereto; receive, via the viewer application, the information inputted by the beneficiary; determine, based on the received information, the beneficiary's intention on how to use the funds designated to the beneficiary, wherein determining includes communicating with the beneficiary via the interactive communication function; and modify the asset structure, with the user's consent, based on determination of the beneficiary's intention.

In some implementations, the software module is further configured to provide an alert to the user if there is a change to the user's accounts, wherein the change includes a purchase with one of the user's accounts, an automated teller machine (ATM) transaction, a transfer of funds from one of the user's accounts to a beneficiary's account, an account withdrawal, an account deposit, the like or any combination thereof.

In some implementations, the software module is further configured to provide periodically an update to the user on the user's accounts status.

In some implementations, the software module is further configured to notify, via the viewer application, to the beneficiaries, of an event associated with the user, wherein the event includes marriage, divorce, new relationship, decease, or the like, and wherein the event is received from the user or from one or more external sources including social media.

In some implementations, inputting the beneficiary information includes modifying, changing, adding, deleting and storing the beneficiary information.

In some implementations, the beneficiary information includes beneficiary's identity of each of the beneficiaries, and wherein the beneficiary's identity includes the beneficiary's name, contact information, relationship with the user and the like.

In some implementations, forming the asset structure includes restructuring the user's existing accounts, creating a shell account for the user's accounts, dividing one or more of the user's accounts into two or more accounts designated to the beneficiaries, creating multiple sub-accounts under one or more of the user's accounts, allocation of funds between two or more accounts designated to the beneficiaries, periodically transferring funds from the user's accounts to one or more accounts designated to the beneficiaries, scheduling payments, budgeting, setting up a trust account, the like or any combination thereof.

In some implementations, the asset structuring application is configured to be launched via a web browser or an online banking application installed on the user's computer or mobile device.

In some implementations, the user's accounts includes a deposit account, a debt account, a savings account, a checking account, an investment account, a money market account, a credit account, the like or any combination thereof.

Other implementations, features and advantages are in the description, drawings and claims.

### BRIEF DESCRIPTION OF THE DRAWINGS

Having thus described embodiments of the invention in general terms, reference may now be made to the accompanying drawings:

FIG. 1 is a block diagram illustrating a system environment including a system for restructuring assets based on intent analysis, in accordance with an embodiment of the invention;

FIG. 2 is a flowchart illustrating a general process for forming an asset structure based on the user intent and planning, in accordance with an embodiment of the present invention; and

FIG. 3 is a flowchart illustrating a general process for modifying the asset structure based on the beneficiary's input, in accordance with an embodiment of the present invention.

### DETAILED DESCRIPTION OF EMBODIMENTS OF THE INVENTION

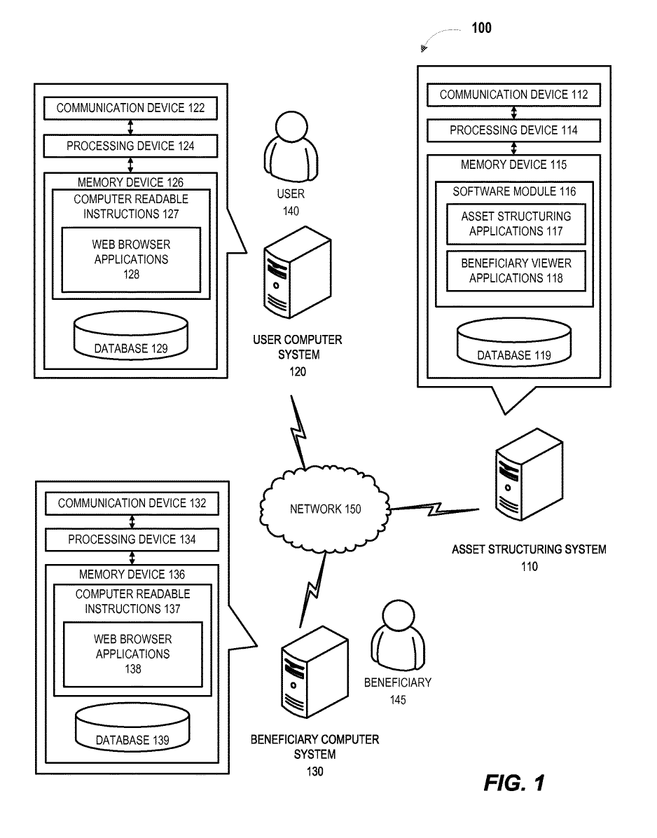

Embodiments of the present invention will now be described with respect to FIGS. 1-3. In the drawings, like reference characters and numbers refer to like elements throughout. Also, the drawings are not necessarily to scale, emphasis instead generally being placed upon illustrating the principles of the invention.

As may be appreciated by one of skill in the art, the present invention may be embodied as a method, system, computer program product, or a combination of the foregoing. Accordingly, the present invention may take the form of an entirely software embodiment (including firmware, resident software, micro-code, the like.) or an embodiment combining software and hardware aspects that may generally be referred to herein as a “system.” Furthermore, embodiments of the present invention may take the form of a computer program product on a computer-readable medium having computer-usable program code embodied in the medium.

In some embodiments, any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a RAM, a read-only memory (ROM), an erasable programmable read-only memory (EPROM or Flash memory), a compact disc read-only memory (CD-ROM), or other optical or magnetic storage device; or transmission media such as those supporting the Internet, an intranet, or a wireless network. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In some embodiments, the computer readable medium is a non-transitory computer readable medium.

Computer program code for carrying out operations of embodiments of the present invention may be written in an object oriented, scripted or unscripted programming language. However, the computer program code for carrying out operations of embodiments of the present invention may also be written in conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention are directed to systems, methods and computer program products for restructuring assets based on analysis of party intent, planning and determination. Some embodiments arise, in part, from the realization that a system and process can advantageously be configured to provide an online asset structuring application that enables a user to access one or more the user's accounts and input beneficiary information including a list of beneficiaries, funds designated to each of the beneficiaries and the user's intended use of the funds designated to each of the beneficiaries. Such embodiments perform analysis on the beneficiary information inputted by the user to determine the user's intention on how to use the funds for each of the beneficiaries, and the analysis can be done through interactive real-time communication with the user via the chat function. Such embodiments formulate an asset structure, based at least partially on determination of the user's intention, and enable the user to verify the asset structure.

Referring now to FIG. 1, a block diagram of a system environment 100 is provided, in accordance with some embodiments of the invention. The system environment 100 includes an asset structuring system 110 owned or administrated by an entity, a user computer system 120, a beneficiary computer system 130, a user 140, a beneficiary 145, and a network 150. The asset structuring system 110, the user computer system 120 and the beneficiary computer system 130 communicate with one another through the network 150.

A “system environment,” as used herein, may refer to any information technology platform of an enterprise, for example, a national or multi-national corporation, and may include a multitude of servers, machines, mainframes, personal computers, network devices, front and back end systems, database systems and/or the like.

An “entity,” as used herein, may refer to any business unit that has authorization to act on behalf of customers with regard to customers' finance management and/or related operation. For example, an entity may be a financial institute or bank.

As used herein, the terms “customer” and “user” are interchangeable, both referring to a person who is affiliated with an entity herein defined. A “beneficiary” refers to a person that receives or will receive assets or funds or other benefits from a user or the entity associated with the asset structuring system. In some embodiments, a beneficiary receives has supplemental rights to one or more accounts of the user, or may have a right to ownership of the user's account after some event or some point in time. The term “party,” as used herein, refers to a user, a beneficiary, or any person associated with either a user or a beneficiary.

As shown in FIG. 1, the asset structuring system 110 includes a communication interface 112, at least one processor 114, and a memory 115. The memory 115 includes a software module 116 including at least one asset structuring application 117 and at least one beneficiary viewer application 118, and a database 119. The communication interface 112 may encompass one more network interface cards, ports for connection of network devices, Universal Serial Bus (USB) connectors and the like. In some embodiments, the asset structuring system 110 may also include a proximity system (not shown), which may include a global positioning system (GPS) or the like.

The processor 114 is operatively coupled to the memory 115 and configured to execute the software module 116. The processor 114 may include a digital signal processor device, a microprocessor device, analog-to-digital converters, digital-to-analog converters, and other support circuits. Control and signal processing functions of the processor 114 may be allocated between these devices according to their respective capabilities. The processor 114 may also include functionality to operate other software programs based on computer executable code thereof, which may be stored, along with the asset structuring application 117 and beneficiary viewer application 118, on the asset structuring system 110.

The memory 115 may include volatile memory, such as RAM having a cache area for the temporary storage of information. The memory 116 may also include non-volatile memory that may be embedded and/or removable. The non-volatile memory may additionally or alternatively include an Electrically Erasable Programmable Read-Only Memory (EEPROM), flash memory, and/or the like.

The software module 116 is stored in the memory 116 and includes the asset structuring application 117 and the beneficiary viewer application 118.

In some embodiments, the asset structuring application 117 that enables a user to access one or more the user's accounts and input beneficiary information, for example, to modify, change, add, and/or delete the beneficiary information. In some implementations, the asset structuring application 117 includes at least one electronic interface including a chat function, through which an agent employed by or associated with the entity can interactively communicate with the user at real-time when the user is entering the beneficiary information, and the chat function can assist the user 140 in inputting the beneficiary information and facilitate the formation of an asset structure.

In some embodiments, the beneficiary viewer application 118 enables each of the beneficiaries to view the beneficiary information associated with the beneficiary, including funds designated to the beneficiary. In some implementations, the beneficiary viewer application 118 is configured to enable the beneficiary to input information including the beneficiary's intended use of the funds. The beneficiary viewer application 118 includes at least one electronic interface including a built-in interactive communication function, through which an agent employed by or associated with the entity can interactively communicate with the beneficiary at real-time when the beneficiary is inputting his intention of using the funds.

In some embodiments, the electronic interface (included in either the asset structuring application 117 or the beneficiary viewer application 118) accommodates one or more input and/or output devices, such as display screens and/or speakers, keys, dials, levers, directional pads, joysticks, accelerometers, controllers, microphones, touchpads, touchscreens, scanners, motion detectors, cameras, and/or the like. In other embodiments, the electronic interface includes a graphic user interface (GUI), which enables a user to interact with electronic devices through direct manipulation of graphical elements on the GUI. The graphic elements include, but are not limited to, checkboxes, buttons, radio buttons, dropdown lists, list boxes, text fields, menu bars, and the like. In most of embodiments, the electronic interface a web-based interface which enables a user to communicate with the asset structuring system 110 through a web browser.

In some embodiments, the chat function and the interactive communication function include the capability of audio, video, messaging, chat-room, texting, or the like, or any combination thereof.

In some embodiments, both the asset structuring application 117 and the beneficiary viewer application 118 can be launched via an Internet portal or an online banking application installed on the user computer system 120, the beneficiary computer system 130, a mobile device of the user 140 that is associated with the user computer system, or a mobile device of the beneficiary 145 that is associated with the beneficiary computer system 130.

The database 119 may archive the user financial information associated with one or more the user's accounts managed by the entity. The database 119 may also store data/results related to and/or used by the asset structuring application 117 and the beneficiary viewer application 118. The asset structuring application 117 and the beneficiary viewer application 118 may perform one or more of the steps and/or sub-steps discussed herein and/or one or more steps not discussed herein.

It will be understood that the asset structuring system 110 may be configured to implement one or more of the various user interfaces and/or process flows described herein. It will also be understood that, in some embodiments, the memory 115 includes other applications. It will also be understood that, in some embodiments, the asset structuring system 110 may be configured to communicate with some external systems (not shown), such as other entity systems, for the purpose of receiving information or events associated with the user 140.

In embodiments shown in FIG. 1, the user computer system 120 includes a communication interface 122, a processor 124 and a memory 126. The memory 126 includes computer readable instructions 127 having one or more web browser applications 128 built therein, and a database 129. In some embodiments, the user computer system 120 may also have one or more online banking applications (not shown) provided by the entity. The user 140 can access the asset structuring application 117 on the asset structuring system 110 through either the web browser applications 128 or the banking applications. The user computer system 120 can be a personal digital assistant, a personal computer, an electronic notebook, a mobile device, or the like.

The beneficiary computer system 130, as shown in FIG. 1, includes a communication interface 132, a processor 134, and a memory 136. The memory 136 includes computer readable code 137 having one or more web browser applications 138 that, in some embodiments, is provided by the entity, and a database 139. In some embodiments, the beneficiary computer system 130 may also have one or more online banking applications (not shown) provided by the entity. Each of the beneficiaries 145 can access the beneficiary viewer application 118 on the system 110 through either the web browser applications 138 or the banking applications. The beneficiary computer system 130 can be a personal digital assistant, a personal computer, an electronic notebook, a mobile device, or the like. In some embodiments, a single beneficiary 145 is associated with the system environment 100. In other environments, multiple beneficiaries 145 are associated with the system environment 100, and each beneficiary 145 may be associated with a separate beneficiary computer system 130, and/or may share one or more beneficiary computer systems 130.

The asset structuring system 110, the user computer system 120 and the beneficiary computer system 130 are each operatively connected to the network 150 and in communication with one another. The network 150 may include various networking interfaces, such as a LAN, a WAN, a global area network (e.g., Internet), or a hybrid thereof.

In some embodiments, the asset structuring system 110 provides the asset structuring application 117 that enables the user 140 to log in and access one or more the user's accounts. The asset structuring application 117 also enables the user 140 to input beneficiary information, for example, to modify, change, add and/or delete the beneficiary information.

In some embodiments, the user's 140 accounts comprises a deposit account, a debt account, a savings account, a checking account, an investment account, a money market account, a credit account, cash, and the like or any combination thereof. In some embodiments, the user's 140 accounts include investment instruments such as stocks, bonds, mutual funds, options, futures, real estate, certificates of deposit (CDs), and the like, or any combination thereof.

In some embodiments, the beneficiary 145 information includes one or more beneficiaries, funds designated to each of the beneficiaries 145 and the user's intended use of the funds designated to each of the beneficiaries 145. In some embodiments, the beneficiary 145 information includes beneficiary's identity of each of the beneficiaries 145, and wherein the beneficiary's 145 identity comprises the beneficiary's 145 name, contact information, age, geographical location, income tax bracket, relationship with the user, income, current accounts, current investment vehicles, other beneficiary statuses, dependents, and the like.

In some embodiments, the asset structuring system 110 receives, via the asset structuring application 117, the beneficiary 145 information inputted by the user 140 from the user computer system 120; and analyze the received beneficiary 145 information to determine the user's 140 intention on how to use the funds and/or accounts designated to each of the beneficiaries 140. In some embodiments, analyzing the beneficiary 145 information includes interactive real-time, or near real-time, communication with the user 140 via the chat function. In some embodiments, analyzing the beneficiary 145 information includes interactive real-time, or near real-time, communication with the one or more beneficiaries 145 via the chat function. The asset structuring system 110 may, in some embodiments, form an asset structure, based on determination of the user's intention, and enables the user to verify the asset structure.

In some embodiments, verifying the asset structure comprises authenticating a transfer of assets and/or ownership of one or more accounts or assets through a notary system. In some embodiments, verifying the asset structure comprises using a Power of Attorney system. In general, any verification, authentication, and/or legal systems may be used by the system to authorize the combination and/or transfer of accounts and assets of a user and one or more beneficiaries. For example, the system may interact with a Power of Attorney system that grants one user a Power of Attorney for the beneficiaries for one or more accounts of the user. As there may be different types and powers for different of Power of Attorney agreements, the system may provide multiple options to the beneficiaries for creating a Power of Attorney for one or more of the users. In some embodiments, the system may interact with a legal system to provide other legal documents and/or services to the user and beneficiaries associated with the user's accounts and assets. For example, the system may communicate with a legal system to retrieve a deed for a real estate asset of the user, and the system may provide that the deed or a document based on the deed to both the user and a first beneficiary to allow the user to appropriately restructure the beneficiary status of the real estate asset for the first beneficiary. In some embodiments, the system may provide a list of available or necessary documents that the user and/or beneficiaries may need to execute to authorize the entity to restructure assets and accounts of the user and/or the beneficiaries based on the intentions of the user and the beneficiaries.

In some embodiments, forming the asset structure includes restructuring the user's 140 existing accounts, creating a shell account for the user's 140 accounts, dividing one or more of the user's 140 accounts into two or more accounts where each of the two or more accounts are designated to one or more of the beneficiaries 145, creating multiple sub-accounts under one or more of the user's 140 accounts, allocation of funds between two or more accounts designated to the beneficiaries, periodically transferring funds from the user's 140 accounts to one or more accounts designated to the beneficiaries 145, scheduling payments from the user's 140 accounts, budgeting, setting up a trust account, creating or editing an investment vehicle, conveying assets, drafting or editing a will, the like, or any combination thereof.

In some embodiments, the asset structuring system 110 provides the beneficiary viewer application 118 that enables each of the beneficiaries 145 to view the beneficiary information associated with the beneficiary 145, including funds designated to the beneficiary 145 and a portion of the asset structure. In other embodiments, the asset structure is transparent to all of the beneficiaries. In some embodiments, the beneficiary viewer application 118 also enables the beneficiary 145 to input information including the beneficiary's 145 intended use of the funds. The asset structuring system 110 receives, via the viewer application, the information inputted by the beneficiary 145 and determines, based on the received information, the beneficiary's 145 intention on how to use the funds designated to him/her.

In some embodiments, determining includes communicating with the beneficiary 145 via the interactive communication function. The asset structuring system 110 may then, in some embodiments, modify the asset structure, with the user's 140 consent, based on determination of the beneficiary's 145 intention. In some embodiments, the asset structuring system 110 modifies the asset structure, with the user's 140 consent, based on a determination of the user's intentions 145 and the beneficiary's 145 intentions. In some embodiments, the asset structure is modified based on feedback from all parties, including the user 140 and all of the beneficiaries, and in such cases, consent of all parties may be obtained before modification of the asset structure.

In some embodiments, the asset structuring system 110 provides an alert to the user 140 if there is a change to the user's 140 accounts, such as a purchase using one of the user's 140 accounts, an automated teller machine (ATM) transaction, a transfer of funds from one of the user's 140 accounts to a beneficiary's 145 account, an account withdrawal, an account deposit, the like or any combination thereof.

In some implementations, the asset structuring system 110 periodically provides an update to the user on the user's accounts status. In some embodiments, the asset structuring system continuously monitors the account status of the user 140, user information, beneficiary information, user intentions, and beneficiary intentions, and may automatically provide an update to the user 140 upon the determination that a change has occurred in the monitored data and information. In such embodiments, the asset structuring system may then provide one or more asset management models to restructure the user's 140 accounts based upon the user's 140 accounts and assets, the intentions of the user 140, the intentions of the beneficiary, or any combination thereof.

In some implementations, the asset structuring system 110 notifies, via the viewer application, to the beneficiaries, of an event associated with the user, wherein the event includes marriage, divorce, new relationship, decease, or the like, and wherein the event is received from the user or from one or more external sources including social media. In some embodiments, the asset structuring system 110 may request additional input from the beneficiaries 145 regarding any changes to the beneficiaries' 145 intentions regarding their beneficiary status to the accounts and/or assets of the user 140. The asset structuring system 110 may, with the consent of the user 140 or an executer or someone with a power of attorney for the user 140, restructure the accounts and/or assets of the user 140 based on the modified intentions of the beneficiaries.

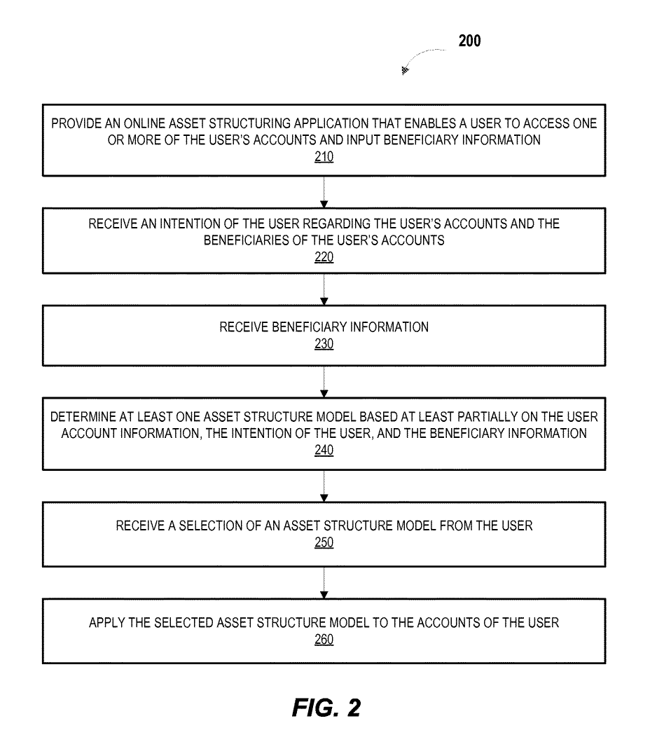

FIG. 2 illustrates a general process flow 200 for forming an asset structure based on the user intent and planning, in accordance with an embodiment of the present invention. The process 200 can be executed by the asset structuring system 110 in the system environment 100, as shown in FIG. 1.

The process 200 includes multiple steps, all performed via at least one processor of an asset structuring system owned, controlled or administrated by an entity. The process 200 may begin with block 210 to provide an online asset structuring application that enables a user to access one or more of the user's accounts and input beneficiary information, including types and amounts of funds designated to the beneficiaries. In some embodiments, the user's accounts are associated with the entity operating the system, and therefore the accounts, and the account information are stored in a database associated with the entity and accessible by the system. As such, the system may retrieve the account information from the database and provide the information to the user.

In some embodiments, the system may establish an electronic communication channel with a user device associated with the user. The user device may comprise input and output devices capable of displaying information to the user and receiving input from the user. Additionally, the user device may communicate information to and from the system via the established electronic communication channel.

In some embodiments, the user does not initially have any accounts or assets established with the entity. In such embodiments, the system may prompt the user device to display a request to the user for the user's account and asset information, beneficiary information, and the like.

In some embodiments, the system includes a chat function for communication between the user and the system via the electronic communication channel and the user device. The chat function may have a built-in capability of audio, video, messaging, chat-room, texting, and/or the like, through which an agent employed by or associated with the entity can interactively converse with the user at real-time or near real-time when the user is connected to the asset structuring system and inputting the beneficiary information. During the conversation, the user may modify, change, add or delete asset information and beneficiary information. The real-time conversation can assist the user through the inputting process, identify and clarify the user's intention on how to use the funds designated to the beneficiaries, and facilitate forming and restructuring the user's assets.

In some embodiments, the process 200 includes block 220, where the system receives an intention of the user regarding the user's accounts and the beneficiaries of the accounts. As used herein, the term “intention” refers to one or more intents of a user or beneficiary regarding the goals and reasoning for establishing accounts and/or for including the beneficiaries in account planning For example, a user's intention may be to save funds for investment in a child's education. In another example, the user's intention may be to protect a certain investment, like real estate, from leaving the family. In some embodiments, the user may have several components to the user's intention. For example, the user may want to save a specified amount of funds for retirement by a certain age, while wanting to save up to pay for a child's education. These intentions generally have significant impacts on how a user can and should structure their accounts and assets, as many investment techniques are available to accomplish many different goals. Therefore, it is important for the system to receive user information about how the user's intentions for the use of the user's assets when establishing or restructuring the user's accounts and assets.

In some embodiments, the system prompts the user device to display a request for the user's intentions. In such embodiments, the system may then receive a user input via the user device describing the user's intention. In some embodiments, the system prompts the user device to display a plurality of common intentions that the user may select as a response. For example, the system may provide common intentions such as “save for education,” “save for real estate,” “aggressive investment,” “conservative investment,” “investment in specific industries,” and the like. In some embodiments, an agent of the entity may communicate directly with the user via the chat function of the system to request and receive the intentions of the user. In such embodiments, the agent of the system may input the user intentions into a database and associate the user intentions with the user account information and any information regarding beneficiaries of the user. In some embodiments, the agent of the entity may prompt the user to input the user's intentions into the user device, whereby the system may receive the user's intentions from the user device via the established electronic communication channel.

The process 200 then progresses to block 230 to receive the beneficiary information inputted by the user. As noted previously, the beneficiary information may include a list of beneficiaries, funds designated to each of the beneficiaries, and the user's intended use of the funds designated to each of the beneficiaries. The beneficiary information may also include beneficiary's identity of each of the beneficiaries, including the beneficiary's name, contact information, age, geographical location, income tax bracket, relationship with the user, income, current accounts, current investment vehicles, other beneficiary statuses, dependents, and the like.

In some embodiments, the system may prompt the user device to display a request to the user for the beneficiary information. In some embodiments, the system may receive the beneficiary information as a user input from the user device. In embodiments with multiple beneficiaries, the system may request beneficiary information for each beneficiary, and likewise receive beneficiary information for each beneficiary. In some embodiments, the user may not know who the beneficiaries will be, and therefore may provide one or more possible beneficiaries. For purposes of this invention, the term “beneficiary” shall encompass possible beneficiaries that may become a beneficiary to one or more accounts of the user at a later point in time.

In some embodiments, the system may only receive contact information associated with the beneficiary from the user. In such embodiments, the system may establish a communication link with a beneficiary device associated with a beneficiary to communicate with the beneficiary. In such embodiments, the system may prompt the beneficiary device do display a request for beneficiary information from the beneficiary. The system may then receive the beneficiary information as an input from the beneficiary device.

In some embodiments of the invention, the process 200 includes block 240, where the system determines at least one asset structure model based at least partially on the user account information, the user intentions, and the beneficiary information. As described above, the user intentions may be weighed heavily in determining which asset structure models are the most appropriate for the user and the beneficiary. For example, if a user has an intention to only provide funds to a beneficiary for the purchase of a car upon the occurrence of an event (e.g., graduating school, turning 18, and the like), then the system may determine that a trust fund is a more appropriate asset structure than a standard checking account for these funds because the beneficiary will not have access to the funs until the occurrence of the event.

In some embodiments, the process 200 includes block 250, where the system receives an asset structure model selection from the user. In some embodiments, the system may prompt the user device to display the determined at least one asset structure models to the user as selectable options. In some embodiments, the system may also prompt the user device to display descriptions of each of the available asset management models, including how each model may accomplish at least portions of the intentions of the user. The system may then receive an indication from the user device of a user selection of one of the asset structure models. In some embodiments, an agent of the system may communicate the available asset management models to the user via the chat function, and may receive the user selection of an asset management model to apply to the user's assets.

In some embodiments, the process 200 includes block 260, where the system applies the selected asset structure model to the assets of the user. In some embodiments, the entity operating the system may already be the managing entity of the user's assets and accounts, and therefore may go ahead and restructure the user's assets upon receiving the user's selection of an asset structure model. In some embodiments, at least a portion of the user's assets and/or accounts may be associated with another entity. In such embodiments, the system may establish a communication link with the other entity to transfer the accounts and/or assets of the user to the entity operating the system before applying the user's assets and accounts to the selected asset structure model.

In some embodiments, forming the asset structure includes restructuring or rearranging the user's existing accounts, creating a shell account for the user's accounts, dividing one or more of the user's accounts into two or more accounts designated to the beneficiaries, crafting multiple sub-accounts under one or more of the user's accounts, the like or any combination thereof. In further embodiments, forming the asset structure encompasses allocation of funds between two or more accounts designated to the beneficiaries, periodically transferring funds from the user's accounts to one or more accounts designated to the beneficiaries, scheduling payments, budgeting, setting up a trust account, and/or the like.

In some embodiments, a user may base their intentions on “fairness” or equity at the time the assets and/or accounts of the user are transferred to multiple beneficiaries. For example, the user may have an intention for two beneficiaries to take an equal amount of assets when their rights are realized, but the assets of the user may be in different forms like a savings account and a real estate property. The system may then look at one of the user's assets like the real estate property, and determine a fair matching value for the other asset like the savings account. By receiving the user's intentions for the beneficiary, the system may be able to provide asset structuring models that take intricacies of the different asset types into account. For example, the system may identify the current value of the savings account, the value in future money, any financial advisor costs associated with the account, and the like. Additionally, the system may identify an estimated real estate price from a database associated with the entity or a separate entity, a trend in real estate value, property tax costs, real estate agent costs, home owner organization costs, and the like for the user's real estate property. The system may then set a fair amount of assets in the savings account to match the value of the real estate property at a current point in time or a future point in time. Additionally, the system may monitor the real estate property and the savings account for new, unexpected, and other value factors for each account and provide new asset structuring models to the user upon a determination that the determined values of each asset are no longer the same.

In some embodiments, the system may prompt a user device associated with the user to display a request for the user input. For example, the system may prompt the user device to display a request for a type-written, oral, video, or other inputted intention message from the user giving and/or explaining the user's intentions for each beneficiary. The system may then receive such an intention message from the user via the user device, and store this intention message as additional information associated with the accounts of the user for each beneficiary. Such a process may allow a user to provide a record of the user's intentions to the beneficiaries of the user's accounts and assets for future reference. For example, system may receive a message from the user indicating the user's intention to name a first beneficiary as a sole beneficiary to the user's first account as a gift that is made in addition to (and not as a part of) the first beneficiary's inheritance from the user. This intention message indicating the “gift” nature of the account's beneficiary status can be associated with and stored with the first account of the user for future reference by the user, the first beneficiary, and any executor of the user's will.

It will also be understood that, in some embodiments, the process 200 can include additional operations that are not shown in FIG. 2. For example, in some cases, the process 200 provides an alert to the user if there is a change to the user's accounts, such as a purchase using one of the user's accounts, an automated teller machine (ATM) transaction, a transfer of funds from one of the user's accounts to a beneficiary's account, an account withdrawal, an account deposit, and/or the like. Alternatively, the process 200 can provides periodically an update to the user on the user's accounts status, including above mentioned changes.

For example, in some embodiments, the process 200 can notify the beneficiaries, of an event associated with the user, such as marriage, divorce, new relationship, decease, or the like. In some incidents, an event associated with the user can be received from the user or from one or more external sources including social media. Upon the occurrence of any such event, the system may request the user for updated user information, user account information, and user intentions. The system may then determine one or more new asset structure models that the user may user to restructure the user's assets, and present these new asset structure models to the user. If the user selects one of the new asset structure models, then the system may restructure the user's assets into the new asset structure model.

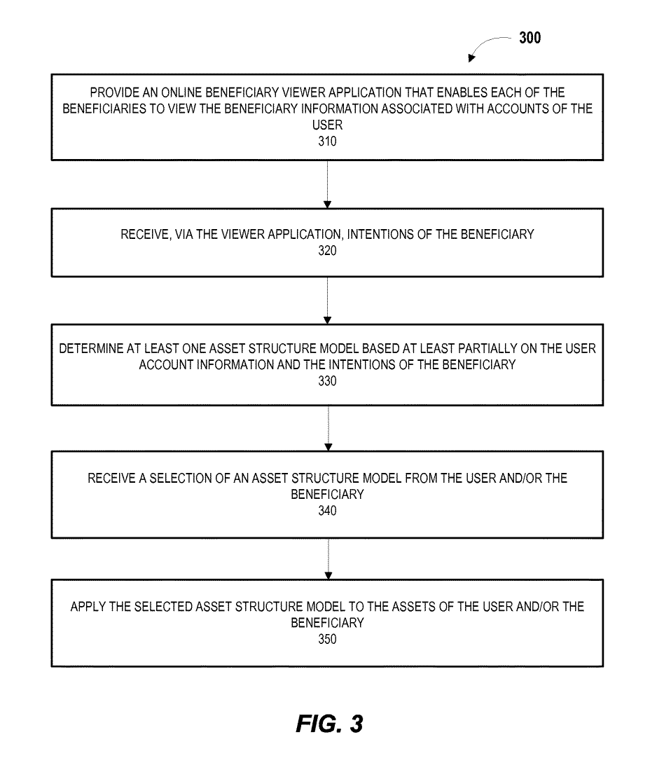

FIG. 3 illustrates a general process flow 300 for modifying the asset structure based on the beneficiary's input. In some embodiments, one or more elements of the process 300 may be used in conjunction with, or in the place of, one or more elements of process 200. In general, the process 300 described herein portrays embodiments of the invention that allow a system to receive intentions of a user that owns accounts and assets, the intentions of beneficiaries (or potential beneficiaries) of the user's accounts, and provide a set of asset structure models from which the user may select to organize the accounts and assets in a manner that benefits both the user and the beneficiary. The system may generate communication between the user and the beneficiary to come to this determination, or at least allow each party to understand how the user's assets can be structured to accommodate each parties' intentions.

At block 310, the process 300 provides an online beneficiary viewer application that enables each of the beneficiaries to view the beneficiary information associated with accounts of the user, including the type and amount of funds designated to the beneficiary by the user. For example, the system may display the user's assets and accounts that the user has previously designated as being associated with the beneficiary. In some embodiments, the system may establish an electronic communication channel with a beneficiary device associated with beneficiaries. The beneficiary device may comprise input and output devices capable of displaying information to the beneficiary and receiving input from the beneficiary. Additionally, the beneficiary device may communicate information to and from the system via the established electronic communication channel.

In some embodiments, the system includes a chat function for communication between the beneficiary and the system via the electronic communication channel and the beneficiary device. The chat function may have a built-in capability of audio, video, messaging, chat-room, texting, and/or the like, through which an agent employed by or associated with the entity can interactively converse with the beneficiary at real-time or near real-time when the beneficiary is connected to the asset structuring system and inputting the beneficiary information. During the conversation, the beneficiary may modify, change, add or delete beneficiary information. The real-time conversation can assist the beneficiary through the inputting process, identify and clarify the beneficiaries' intentions on how to use the funds designated to the beneficiaries, and facilitate forming and restructuring the user's assets.

In some embodiments, the process 300 includes block 320, where the system receives intentions of the beneficiary. The intentions of the beneficiary are the goals for funds that may be received from user accounts at some later point in time. For example, a beneficiary's intention may be to save funds for investment in a child's education. In another example, the beneficiary's intention may be to create or grow a certain investment, like real estate, stocks, and the like. In some embodiments, the beneficiary may have several components to the beneficiary's intention. For example, the beneficiary may want to receive as many assets as possible as well as donate at least a portion to a charity. These intentions generally have significant impacts on how a user can and should structure their accounts and assets, as many investment techniques are available to accomplish many different goals. Therefore, it is important for the system to receive beneficiary information about how the beneficiaries' intentions for the use of the user's assets when establishing or restructuring the user's accounts and assets. For example, if the beneficiary's goal is to purchase a house, then the system may try to structure the user's assets to invest in real estate or invest in an aggressive investment vehicle to best accommodate the beneficiary's desires.

In some embodiments, the system prompts the beneficiary device to display a request for the beneficiary's intentions. In such embodiments, the system may then receive a beneficiary input via the beneficiary device describing the beneficiary's intention. In some embodiments, the system prompts the beneficiary device to display a plurality of common intentions that the beneficiary may select as a response. For example, the system may provide common intentions such as “save for education,” “save for real estate,” “aggressive investment,” “conservative investment,” “investment in specific industries,” and the like. In some embodiments, an agent of the entity may communicate directly with the beneficiary via the chat function of the system to request and receive the intentions of the beneficiary. In such embodiments, the agent of the system may input the beneficiary intentions into a database and associate the beneficiary intentions with the user account information, user intentions, and/or beneficiary information. In some embodiments, the agent of the entity may prompt the beneficiary to input the user's intentions into beneficiary user device, whereby the system may receive the beneficiary's intentions from the beneficiary device via the established electronic communication channel.

In some embodiments, the system limits or otherwise organizes the information displayed to the beneficiaries based on default rules or input from the user and/or each beneficiary. For example, the system may provide a limit to which information is provided to each beneficiary to give the beneficiary only a limited or general understanding of the user's assets. The system could simply display an indication to each beneficiary that the user intends to name each individual as a beneficiary to one or more accounts and/or assets, and the system could further provide the asset and/or account type associated with each beneficiary without disclosing the amount. Additionally or alternatively, the system may inform the beneficiaries of an amount of an account or asset that the user intends to associate with each beneficiary without disclosing the amount of the asset or account. As such, the user may be able to conceal or otherwise keep private one or more aspects of the user's accounts and assets while still allowing the beneficiaries the opportunity to make an intention decision based on important user account considerations.

In some embodiments, the process 300 includes step 330 of determining at least one asset structure model based at least partially on the user account information and the intentions of the beneficiary. In some embodiments, the system also makes the determination of the at least one asset structure model based at least partially on the intentions of the user. In such embodiments, the system may weigh the intentions of the user higher than the intentions of the beneficiary, or only account for the intentions of the beneficiary when they do not conflict with the intentions of the user. As described above, the user and beneficiary intentions may be weighted heavily in determining which asset structure models are the most appropriate for the user and the beneficiary. For example, if the user has intentions of maintaining at least one aggressive investment vehicle and at least one conservative investment vehicle, and if a first beneficiary has intentions of receiving as much funds as possible, the system may structure the assets of the user in aggressive investment vehicles for the first beneficiary and possibly name other beneficiaries to the more conservative investment vehicles. In some embodiments, the system may establish a chat function between the user, the beneficiary, and/or an agent of the entity to discuss the available asset structure models.

In some embodiments, the process 300 includes block 340, where the system receives an asset structure model selection from the user and/or the beneficiary. In some embodiments, the system may prompt the user device to display the determined at least one asset structure models to the user as selectable options. In some embodiments, the system may also prompt the user device to display descriptions of each of the available asset management models, including how each model may accomplish at least portions of the intentions of the user. The system may then receive an indication from the user device of a user selection of one of the asset structure models. In some embodiments, an agent of the system may communicate the available asset management models to the user via the chat function, and may receive the user selection of an asset management model to apply to the user's assets.

In some embodiments, the system may also receive a selection, suggestion, and/or confirmation from the beneficiary indicating an acceptance of at least one of the available asset structure model selections. For example, in some embodiments, the system may determine that a periodic payment system may be a good asset structure model to convey the most amount of funds from the user to the beneficiary, for tax purposes. The system may therefore prompt the beneficiary for an acceptance of the structure such that the entity operating the system may have authority to adjust accounts of the beneficiary to accommodate the asset model structure that may be selected by the user.

In some embodiments, the process 300 includes block 350, where the system applies the selected asset structure model to the assets of the user and/or the beneficiary. In some embodiments, the entity operating the system may already be the managing entity of the user's assets and accounts, and therefore may go ahead and restructure the user's assets upon receiving the user's selection of an asset structure model. In some embodiments, at least a portion of the user's assets and/or accounts may be associated with another entity. In such embodiments, the system may establish a communication link with the other entity to transfer the accounts and/or assets of the user to the entity operating the system before applying the user's assets and accounts to the selected asset structure model.

In some embodiments, the entity operating the system may already be the managing entity of the beneficiary's assets and accounts, and therefore may go ahead and restructure the beneficiary's assets upon receiving the user's and/or the beneficiary's selection of an asset structure model. In some embodiments, at least a portion of the beneficiary's assets and/or accounts may be associated with another entity. In such embodiments, the system may establish a communication link with the other entity to transfer the accounts and/or assets of the beneficiary to the entity operating the system before applying the beneficiary's assets and accounts to the selected asset structure model.

In some embodiments, forming the asset structure includes restructuring or rearranging the user's existing accounts, creating a shell account for the user's accounts, dividing one or more of the user's accounts into two or more accounts designated to the beneficiaries, crafting multiple sub-accounts under one or more of the user's accounts, the like or any combination thereof. In further embodiments, forming the asset structure encompasses allocation of funds between two or more accounts designated to the beneficiaries, periodically transferring funds from the user's accounts to one or more accounts designated to the beneficiaries, scheduling payments, budgeting, setting up a trust account, and/or the like. In some embodiments, forming the asset structure includes restructuring or rearranging the beneficiary's existing accounts, creating a shell account for the beneficiary's accounts, crafting multiple sub-accounts under one or more of the beneficiary's accounts, the like or any combination thereof.

It will also be understood that, in some embodiments, the process 300 can include additional operations that are not shown in FIG. 3. For example, in some cases, the process 300 provides an alert to the user if there is a change to the user's accounts, such as a purchase using one of the user's accounts, an automated teller machine (ATM) transaction, a transfer of funds from one of the user's accounts to a beneficiary's account, an account withdrawal, an account deposit, and/or the like. Alternatively, the process 300 can provides periodically an update to the user on the user's accounts status, including above mentioned changes.

For example, in some embodiments, the process 300 can notify the beneficiaries, of an event associated with the user, such as marriage, divorce, new relationship, decease, or the like. In some incidents, an event associated with the user can be received from the user or from one or more external sources including social media. Upon the occurrence of any such event, the system may request the user for updated user information, user account information, and user intentions. The system may then determine one or more new asset structure models that the user may user to restructure the user's assets, and present these new asset structure models to the user. If the user selects one of the new asset structure models, then the system may restructure the user's assets into the new asset structure model.

Although a number of implementations have been described in detail above, other modifications, variations and implementations are possible in light of the foregoing teaching. The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. As used herein, all numbers may be read as if prefaced by the term “about,” even if the term does not expressly appear. Also, any numerical range recited herein is intended to include all sub-ranges subsumed therein. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. Thus, although not expressly described, any or each of the features of the invention disclosed herein may be combined in any manner.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 6810US1.014033.2511 | 14/851,750 | SYSTEM FOR RESTRUCTURING | Sep. 11, 2015 |
| | | BASED ON PREDICTIVE ANALYSIS | |
| 6811US1.014033.2512 | 14/851,758 | UNIVERSAL TOKENIZATION | Sep. 11, 2015 |
| | | SYSTEM | |
| 6812US1.014033.2513 | 14/851,599 | SYSTEM FOR MODELING AND | Sep. 11, 2015 |
| | | IMPLEMENTING EVENT- | |
| | | RESPONSIVE RESOURCE | |
| | | ALLOCATION STRUCTURES | |
| 6813US1.014033.2514 | 14/851,623 | SYSTEM FOR SIMULATION AND | Sep. 11, 2015 |
| | | IMPLEMENTATION OF DYNAMIC | |
| | | STATE-DEPENDENT RESOURCE | |
| | | RECONFIGURATION | |
| 6815US1.014033.2515 | 14/851,848 | SYSTEM FOR DYNAMIC | Sep. 11, 2015 |
| | | VISUALIZATION OF | |
| | | INDIVIDUALIZED CONSUMPTION | |
| | | ACROSS SHARED RESOURCE | |
| | | ALLOCATION STRUCTURE | |
| 6817US1.014033.2516 | 14/851,765 | SYSTEM FOR ANALYZING PRE- | Sep. 11, 2015 |
| | | EVENT AND POST-EVENT | |
| | | INDIVIDUAL ACCOUNTS AND | |
| | | TRANSFORMING THE ACCOUNTS | |
| 6818US1.014033.2517 | 14/851,769 | SYSTEM FOR OPENING AND | Sep. 11, 2015 |
| | | CONSOLIDATING ACCOUNTS | |
| | | BASED ON AN EVENT | |
| | | ASSOCIATED WITH THE ACCOUNT | |
| | | HOLDER | |
| 6824US1.014033.2518 | | SYSTEM FOR DETERMINATION | Concurrently |
| | | AND TRACKING OF ASSET | Herewith |
| | | LINEAGE | |
| 6825US1.014033.2519 | | SYSTEM FOR DETERMINATION | Concurrently |
| | | AND TRANSFER OF ASSETS | Herewith |
| 6827US1.014033.2521 | | SYSTEM FOR ASSESSMENT OF | Concurrently |
| | | ALLOCATED ASSETS | Herewith |
| 6828US1.014033.2522 | | SYSTEM FOR DYNAMIC | Concurrently |
| | | GENERATION OF ALLOCATION | Herewith |
| | | GUIDE FOR ASSETS | |

What is claimed is:

1. A system for restructuring assets based on intent analysis, the system comprising:
a computer apparatus comprising at least one processor and a memory; and
a software module, stored in the memory, comprising computer readable code, executable by the processor, and configured to:
provide an asset structuring application that enables a user to access one or more of the user's accounts and input beneficiary information, the asset structuring application comprising at least one electronic interface comprising a chat function, wherein the beneficiary information comprises a beneficiary and funds designated to the beneficiary;
receive, via the asset structuring application, the beneficiary information inputted by the user;
receive, via the asset structuring application, intentions of the user, wherein the intentions of the user comprise goals and desired investment strategies of the user and reasons for associating the beneficiary with the accounts of the user;
determine at least one asset structure model based at least partially on the user account information, the intentions of the user, and the beneficiary information;
prompt the electronic interface to display the determined at least one asset structure model to the user;
receive an indication from the electronic interface that the user has selected a first asset structure model from the at least one asset structure model; and
apply the first asset structure model to the accounts of the user.

2. The system of claim 1, wherein the software module is further configured to:
provide a beneficiary viewer application that enables the beneficiary to view the user account information and beneficiary information associated with the beneficiary, the viewer application comprising at least one electronic interface comprising an interactive communication function and configured to enable the beneficiary to input information comprising the intentions of the beneficiary for the funds designated thereto;
receive, via the viewer application, intentions of the beneficiary, wherein the intentions of the beneficiary comprise goals for funds that the beneficiary may receive from the accounts of the user at some later point in time; and
determine the at least one asset structure model based at least partially on the user account information, the intentions of the user, and the intentions of the beneficiary.

3. The system of claim 1, wherein the software module is further configured to:
continuously monitor the accounts of the user;
determine that a change in the accounts of the user has occurred, wherein the change to the accounts of the user comprises a purchase with one of the accounts of the user, an automated teller machine (ATM) transaction, a transfer of funds from one of the accounts of the user to an account associated with the beneficiary, an account withdrawal, or an account deposit; and
provide an alert to the user if there is a change to the accounts of the user.

4. The system of claim 1, wherein the software module is further configured to:
notify, via the viewer application, the beneficiary, of an event associated with the user, wherein the event comprises marriage, divorce, or new relationship, and wherein the event is received from the user or from one or more external sources comprising social media;
prompt the beneficiary to provide updated intentions regarding the accounts associated with the user;
determine at least one updated asset structure model based at least partially on the user account information, the intentions of the user, and the updated intentions of the beneficiary.

5. The system of claim 1, wherein inputting the beneficiary information comprises modifying, changing, adding, deleting and storing the beneficiary information.

6. The system of claim 1, wherein the beneficiary information comprises the identity of the beneficiary, and wherein the identity of the beneficiary comprises the beneficiary's name, contact information, relationship with the user and the like.

7. The system of claim 1, wherein forming the asset structure comprises restructuring existing accounts of the user, creating a shell account for the accounts of the user, dividing one or more of the accounts of the user into two or more accounts designated to the beneficiary, creating multiple sub-accounts under one or more of the accounts of the user, allocation of funds between two or more accounts designated to the beneficiary, periodically transferring funds from the accounts of the user to one or more accounts designated to the beneficiary, scheduling payments, budgeting, setting up a trust account, the like or any combination thereof.

8. The system of claim 1, wherein the asset structuring application is configured to be launched via a web browser or a banking application installed on a computer or mobile device associated with the user.

9. The system of claim 1, wherein the accounts associated with the user comprise a deposit account, a debt account, a savings account, a checking account, an investment account, a money market account, a credit account, stocks, bonds, certificates of deposit, cash, or mutual funds.

10. A computer-implemented method for restructuring assets based on intent analysis, the computer-implemented method comprising:
providing an asset structuring application that enables a user to access one or more of the user's accounts and input beneficiary information, the asset structuring application comprising at least one electronic interface comprising a chat function, wherein the beneficiary information comprises a beneficiary and funds designated to the beneficiary;
receiving, via the asset structuring application, the beneficiary information inputted by the user;
receiving, via the asset structuring application, intentions of the user, wherein the intentions of the user comprise goals and desired investment strategies of the user and reasons for associating the beneficiary with the accounts of the user;
determining at least one asset structure model based at least partially on the user account information, the intentions of the user, and the beneficiary information;
prompting the electronic interface to display the determined at least one asset structure model to the user;
receiving an indication from the electronic interface that the user has selected a first asset structure model from the at least one asset structure model; and
applying the first asset structure model to the accounts of the user.

11. The computer-implemented method of claim 10 further comprising:
providing a beneficiary viewer application that enables the beneficiary to view the user account information and beneficiary information associated with the beneficiary, the viewer application comprising at least one electronic interface comprising an interactive communication function and configured to enable the beneficiary to input information comprising the intentions of the beneficiary for the funds designated thereto;
receiving, via the viewer application, intentions of the beneficiary, wherein the intentions of the beneficiary comprise goals for funds that the beneficiary may receive from the accounts of the user at some later point in time; and
determining the at least one asset structure model based at least partially on the user account information, the intentions of the user, and the intentions of the beneficiary.

12. The computer-implemented method of claim 10 further comprising:
providing an alert to the user if there is a change to the user's accounts, wherein the change comprises a purchase with one of the user's accounts, an automated teller machine (ATM) transaction, a transfer of funds from one of the user's accounts to a beneficiary's account, an account withdrawal, an account deposit, the like or any combination thereof.

13. The computer-implemented method of claim 10 further comprising:
continuously monitoring the accounts of the user;
determining that a change in the accounts of the user has occurred, wherein the change to the accounts of the user comprises a purchase with one of the accounts of the user, an automated teller machine (ATM) transaction, a transfer of funds from one of the accounts of the user to an account associated with the beneficiary, an account withdrawal, or an account deposit; and
providing an alert to the user of the change to the accounts of the user.

14. The computer-implemented method of claim 10 further comprising:
notifying, via the viewer application, the beneficiary, of an event associated with the user, wherein the event comprises marriage, divorce, or new relationship, and wherein the event is received from the user or from one or more external sources comprising social media;
prompting the beneficiary to provide updated intentions regarding the accounts associated with the user;
determining at least one updated asset structure model based at least partially on the user account information, the intentions of the user, and the updated intentions of the beneficiary.

15. The computer-implemented method of claim 10, wherein inputting the beneficiary information comprises modifying, changing, adding, deleting and storing the beneficiary information.

16. The computer-implemented method of claim 10, wherein forming the asset structure comprises restructuring existing accounts of the user, creating a shell account for the accounts of the user, dividing one or more of the accounts of the user into two or more accounts designated to the beneficiary, creating multiple sub-accounts under one or more of the accounts of the user, allocation of funds between two or more accounts designated to the beneficiary, periodically transferring funds from the accounts of the user to one or more accounts designated to the beneficiary, scheduling payments, budgeting, setting up a trust account, the like or any combination thereof.

17. The computer-implemented method of claim 10, wherein the accounts associated with the user comprise a deposit account, a debt account, a savings account, a checking account, an investment account, a money market account, a credit account, stocks, bonds, certificates of deposit, cash, or mutual funds.

18. A computer program product for restructuring assets based on intent analysis, the computer program product comprising a non-transitory computer readable medium having one or more computer-readable programs stored therein, and the computer readable programs, when executed by a computer apparatus, cause the computer apparatus to perform the following steps:
providing, via a processing device, an asset structuring application that enables a user to access one or more of the user's accounts and input beneficiary information, the asset structuring application comprising at least one electronic interface comprising a chat function, wherein the beneficiary information comprises a beneficiary and funds designated to the beneficiary;
receiving, via a processing device, and via the asset structuring application, the beneficiary information inputted by the user;
receive, via a processing device, and via the asset structuring application, intentions of the user, wherein the intentions of the user comprise goals and desired investment strategies of the user and reasons for associating the beneficiary with the accounts of the user;
determining, via a processing device, at least one asset structure model based at least partially on the user account information, the intentions of the user, and the beneficiary information;
prompting, via a processing device, the electronic interface to display the determined at least one asset structure model to the user;
receiving, via a processing device, an indication from the electronic interface that the user has selected a first asset structure model from the at least one asset structure model; and
applying, via a processing device, the first asset structure model to the accounts of the user.

19. The computer program product of claim 18, wherein the computer readable programs, when executed by a computer apparatus, cause the computer apparatus to perform the following steps:
providing, via a processing device, a beneficiary viewer application that enables the beneficiary to view the user account information and beneficiary information associated with the beneficiary, the viewer application comprising at least one electronic interface comprising an interactive communication function and configured to enable the beneficiary to input information comprising the intentions of the beneficiary for the funds designated thereto;
receiving, via a processing device, and via the viewer application, intentions of the beneficiary, wherein the intentions of the beneficiary comprise goals for funds that the beneficiary may receive from the accounts of the user at some later point in time; and
determining, via a processing device, the at least one asset structure model based at least partially on the user account information, the intentions of the user, and the intentions of the beneficiary.

20. The computer program product of claim 18, wherein the computer readable programs, when executed by a computer apparatus, cause the computer apparatus to perform the following steps:
continuously monitoring, via a processing device, the accounts of the user;
determining, via a processing device, that a change in the accounts of the user has occurred, wherein the change to the accounts of the user comprises a purchase with one of the accounts of the user, an automated teller machine (ATM) transaction, a transfer of funds from one of the accounts of the user to an account associated with the beneficiary, an account withdrawal, or an account deposit; and
providing, via a processing device, an alert to the user if there is a change to the accounts of the user.
